(19) United States
(12) Patent Application Publication
(10) Pub. No.: US 2025/0345996 A1
(43) Pub. Date: Nov. 13, 2025

(54) SYSTEMS, APPARATUS, AND METHODS FOR MANUFACTURING FOAM INSERTS FOR FUEL TANKS

(71) Applicant: The Boeing Company, Arlington, VA (US)

(72) Inventors: Howard T. Rolleston, Glen Mills, PA (US); Thomas Edward Boyle, Avondale, PA (US); Antonio Paesano, Wilmington, DE (US)

(21) Appl. No.: 18/660,972

(22) Filed: May 10, 2024

(51) Int. Cl. B29C 64/30; B29C 64/209; B29C 64/241; B29C 71/02; B29K 75/00; B29K 105/04; B33Y 10/00; B33Y 30/00; B33Y 40/20

(52) U.S. Cl. CPC B29C 64/30; B29C 64/209; B29C 64/241; B29C 71/02; B33Y 10/00; B33Y 30/00; B33Y 40/20; B29C 2071/025; B29K 2075/00; B29K 2105/04

(57) ABSTRACT

Systems, apparatus, and methods for manufacturing foam inserts for fuel tanks are disclosed. An example method includes forming, via additive manufacturing, a foam insert having a shape based on one or more properties of a fuel tank that is to receive the foam insert; and quenching the foam insert to form a reticulated foam insert.

### FIELD OF THE DISCLOSURE

This disclosure relates generally to fuel tanks and, more particularly, to systems, apparatus, and methods for manufacturing foam inserts for fuel tanks.

### BACKGROUND

Insertion of foam into fuel tanks can prevent fuel from igniting by minimizing the area in which gas can form and collect as vapor. For example, electrical arcing due to a lightning strike can result from electrical charges moving from less conductive composite materials to more conductive materials (e.g., metal). Electrical arcing can create sparks, which can cause gaseous vapor in the fuel tanks to ignite. The substantial reduction or elimination of sloshing actions as result of including foam inserts in the fuel tanks can prevent vaporization of the fuel from a liquid state to a gaseous state.

### BRIEF DESCRIPTION OF THE DRAWINGS

FIG. 1 illustrates an example aircraft including example fuel tanks in which examples herein may be implemented.

FIG. 2 illustrates example arrangement of foam inserts for a fuel tank in accordance with teachings of this disclosure.

FIG. 3 is another example arrangement of foam inserts for a fuel tank in accordance with teachings of this disclosure.

FIG. 4 illustrates example foam insert in accordance with teachings of this disclosure.

FIG. 5 illustrates another example foam insert in accordance with teachings of this disclosure.

FIG. 6 is a block diagram of an example system including a printer and example printer control circuitry for forming foam inserts via additive manufacturing in accordance with teachings of this disclosure

FIGS. 7-12 illustrate portions of an example foam insert formed using the example printer of FIG. 6 based on instructions generated by the example printer control circuitry of FIG. 6.

FIG. 13 is a flowchart of an example method for manufacturing a foam insert such as the example foam insert of FIG. 4 in accordance with teachings of this disclosure.

FIG. 14 is a flowchart representative of example machine-readable instructions and/or example operations that may be executed, instantiated, and/or performed by example programmable circuitry to implement the printer control circuitry of FIG. 6 to form a foam insert such as the example foam insert of FIG. 5.

FIG. 15 is a block diagram of an example processing platform including programmable circuitry structured to execute, instantiate, and/or perform the example machine-readable instructions and/or perform the example operations of FIGS. 13 and/or 14 to implement the printer control circuitry of FIG. 6.

In general, the same reference numbers will be used throughout the drawing(s) and accompanying written description to refer to the same or like parts. The figures are not necessarily to scale.

### DETAILED DESCRIPTION

An aircraft typically carries fuel tanks in wings and/or a fuselage of the aircraft. However, factors such as the material of the fuel tanks, electrical wiring proximate to the fuel tanks, etc. can create a risk of fuel vapor ignition in the fuel tanks. For instance, electrical arcing due to a lightning strike can result from electrical charges moving from less conductive composite materials of the aircraft to more conductive materials (e.g., metal). Sparks resulting from travel of the electrical charges during arcing can cause gaseous vapors associated with fuel in the fuel tanks to ignite.

To prevent or mitigate the risks of ignition of fuel vapor in a fuel tank due to electrical arcing or other sources of electrical sparking (e.g., faulty wiring), inserts made of foam can be disposed in the tank to reduce sloshing and concentration of the fuel vapor. For instance, foam inserts can occupy a substantial volume (e.g., 90%) of the fuel tank to provide for electrical arc suppression by dividing the fuel tank into sections to prevent accumulation of flammable fuel gasses or vapors.

Structural features of fuel tanks for an aircraft can vary. For example, a shape of the fuel tank can be designed to accommodate spars, ribs, pipes, and/or other structural features of a wing of the aircraft. Also, the fuel tank can include sensors such as fuel level sensors in the interior of the fuel tank. The presence of sensors in the fuel tank as well as structural features of the aircraft can affect the shape, size, volume, layout, etc. of the fuel tank.

Foam inserts for fuel tanks can be formed from reticulated polyurethane foam, which is porous and low density. To form reticulated foam, the polyurethane foam undergoes a chemical quenching process in which the foam is exposed to a caustic bath to remove cell membranes of the foam and create voids, open cells, or pockets in the polyurethane, thereby creating foam with low flow restriction. After the quenching process, the foam (e.g., foam buns or blocks) can be cut into shapes according to the structural features or properties of the fuel tank in which the foam insert is to be inserted (e.g., size, shape, presence of sensor(s), piping, etc.). The quenched foam buns can be cut using die or hand cutting. Thus, known methods for forming foam inserts typically involve subtractive manufacturing in which foam buns are shaped after quenching. However, cutting foam buns into various shapes after quenching is a laborious and costly process, particularly given that some aircraft include hundreds or thousands of foam inserts that need to be installed and replaced as part of maintenance procedures over the life of the aircraft.

Disclosed herein are systems, apparatus, and methods that provide for creation of foam inserts for fuel tanks using additive manufacturing. In examples disclosed herein, a foam insert is created by printing or depositing a material such as polyurethane in a shape that accounts for features of the fuel tank in which the foam insert is to be received. For example, the foam insert can be printed in a shape that includes curved surfaces, grooves, etc. that accommodate structures such as sensors, spars, ribs, etc. associated with the fuel tank and/or the location of the fuel tank in the wing or fuselage of the aircraft. The pre-shaped foam can then be quenched to form a reticulated foam insert for the fuel tank. Thus, as compared to known techniques for forming foam inserts that use subtractive manufacturing to shape the foam buns after quenching, examples disclosed herein reduce the labor and tooling involved in creating foam inserts that accommodate structural features of a fuel tank.

Some examples disclosed herein build a solid block having a particular shape as defined by three-dimensional (3D) model by depositing layers of a material such as thermal polyurethane based on the 3D model. In such examples, the solid foam shape is then quenched to form a reticulated foam insert having pockets or voids for low flow resistance.

Some examples disclosed herein create foam insert shapes by forming a lattice foam structure that includes pockets or voids. The foam lattice structure can be formed by an extruder depositing a heated material such as thermal polyurethane along a toolpath to form a lattice pattern. A shape (e.g., a perimeter or outline) defined by the lattice pattern can be based on the properties of fuel tank in which the foam insert is to be installed. Multiple extruders can be used simultaneously or substantially simultaneously to form different portions of the lattice pattern. Because the lattice pattern defines pockets between the foam material, the foam insert does not need to be quenched.

In examples disclosed herein, a controller causes the extruder to rotate to change the angle of extrusion to define the lattice pattern. In particular, examples disclosed herein provide for an extruder including a printhead that rotates in a fore-aft direction. Rotation of the printhead in the fore-aft direction when forming the lattice pattern allows material to exit a nozzle of the extruder without smearing against an outside surface of the nozzle. As a result, examples disclosed herein provide creation of a foam insert via an extruder that moveable (e.g., translation, rotation) along multiple axes (e.g., x-y-z axes, a w-axis for fore-aft movement) to form a lattice pattern. Further, because example extruders disclosed herein can move and rotate relative to the z-axis, example lattice foam patterns disclosed herein can have heights that are larger than structures formed based on known material extrusion tool paths.

Although examples disclosed herein are discussed in connection with air vehicles, examples disclosed herein can be implemented in other vehicles (e.g., land vehicles) including fuel tanks. Thus, examples disclosed herein are not limited to use in fuel tanks of air vehicles.

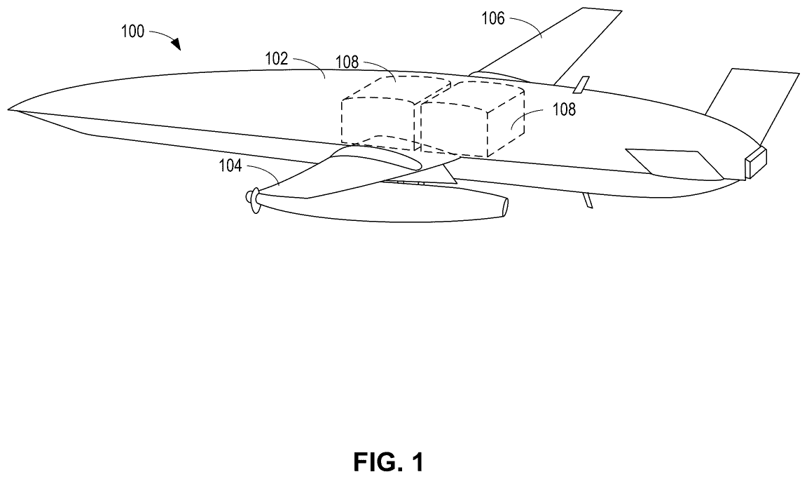

FIG. 1 illustrates an example aircraft 100 in which examples disclosed herein may be implemented. The example aircraft 100 includes a fuselage 102 and wings 104, 106. The example aircraft 100 is an autonomous vehicle. However, the aircraft 100 can include other types aircraft, including unmanned aircraft or manned aircraft (e.g., a passenger aircraft, a cargo plane).

The example aircraft 100 of FIG. 1 carries one or more fuel tanks 108 including fuel stored therein. In the example of FIG. 1, the fuel tanks 108 are in the fuselage 102 of the aircraft 100. However, the fuel tanks 108 can additionally or alternatively be in the wings 104, 106 of the aircraft 100. Although two fuel tanks 108 are shown in the example of FIG. 1, the aircraft 100 can carry different numbers of fuel tanks 108 (e.g., one, ten, twenty fuel tanks). The fuel tanks 108 can have different shapes than the examples shown in FIG. 1.

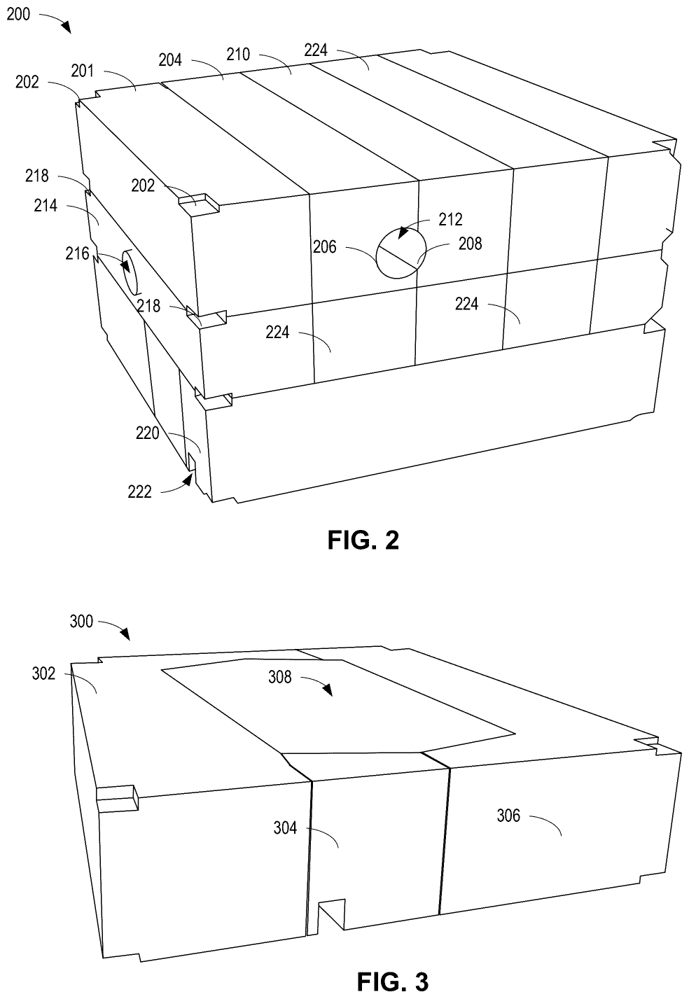

FIG. 2 illustrates an example arrangement 200 of a plurality of foam inserts in a fuel tank (not shown), such as the example fuel tank 108 of FIG. 1. As shown in FIG. 2, the foam inserts can define layers that occupy a portion of an interior of the fuel tank. Additional or fewer foam inserts than shown in FIG. 2 can be included in the fuel tank. In some examples, the foam inserts occupy a substantial portion of the interior volume of the fuel tank, such as 90% of the fuel tank volume. The foam inserts can be made of a material such as polyurethane. The foam inserts serve to reduce sloshing of fuel in the fuel tank. Additionally, the presence of the foam inserts in the fuel tank reduces space in the interior of the fuel tank for fuel gas (e.g., vapor or fuel/air mixture) to accumulate in the fuel tank. As a result, the foam inserts minimize risks of ignition of the fuel vapor due to, for example, electrical arcing from a lightning strike (e.g., a direct lighting strike, an indirect lighting strike to a different part of the aircraft such as the engine).

As disclosed herein, structural components of an aircraft (e.g., the aircraft 100 of FIG. 1), such as ribs, spars, etc. may be at least partially disposed in the fuel tank and/or disposed proximate to the fuel tank such that the shape, size, etc. of the fuel tank is affected. Also, sensor(s) may be in an interior of the fuel tank. In accordance with teachings of this disclosure, the example foam inserts of FIG. 2 are formed via additive manufacturing. As disclosed herein, the formation of one or more of the foam inserts via additive manufacturing accounts for structure(s) of the aircraft that may occupy at least some portion the volume of the fuel tank and/or affect a shape, layout, size, etc. of the fuel tank because of the proximity of the structures to the fuel tank. For example, based on the location a sensor in an interior of the fuel tank, one or more foam inserts can be formed to include a groove, a slot, an opening, etc. to accommodate the sensor when the foam insert is in the fuel tank.

For example, a first foam insert 201 of FIG. 2 is formed to include notched surfaces 202 formed in corners of the foam insert 201. A second foam insert 204 is built to include a curved surface 206 that can be aligned with a curved surface 208 of a third foam insert 210 to define an opening 212 extending through the foam inserts, as shown in FIG. 2. A fourth foam insert 214 is formed to include an opening 216 and notched surfaces 218. A fifth foam insert 220 is built to include a slot 222 defined in one of the surfaces of the fifth foam insert 220. The notched surfaces, openings, slots, etc. shown in FIG. 2 can accommodate the presence of, for example, ribs, spars, sensors, etc. associated fuel tank at the locations at which the foam inserts are disposed in the fuel tank. Other foam inserts 224 may not include any notches or slots based on, for example, the location of those foam inserts in the fuel tank and the properties of the fuel tank and/or other structures at those locations. The example foam inserts of FIG. 2 can have different sizes, shapes, features, arrangements, etc. than shown in FIG. 2.

FIG. 3 illustrates another arrangement 300 of foam inserts in accordance with teachings of this disclosure. The foam insert arrangement 300 of FIG. 3 can define, for example, a layer of the example foam insert arrangement 200 of FIG. 2. In the example of FIG. 3, a first foam insert 302, a second foam insert 304, and a third foam insert 306 define an opening 308 in which fuel of the fuel tank can be received. Other foam inserts can be disposed around the opening 308, covering the opening 308, etc. (e.g., forming layers as shown in FIG. 2). The foam inserts can be arranged relative to an access panel of the fuel tank to facilitate foam placement.

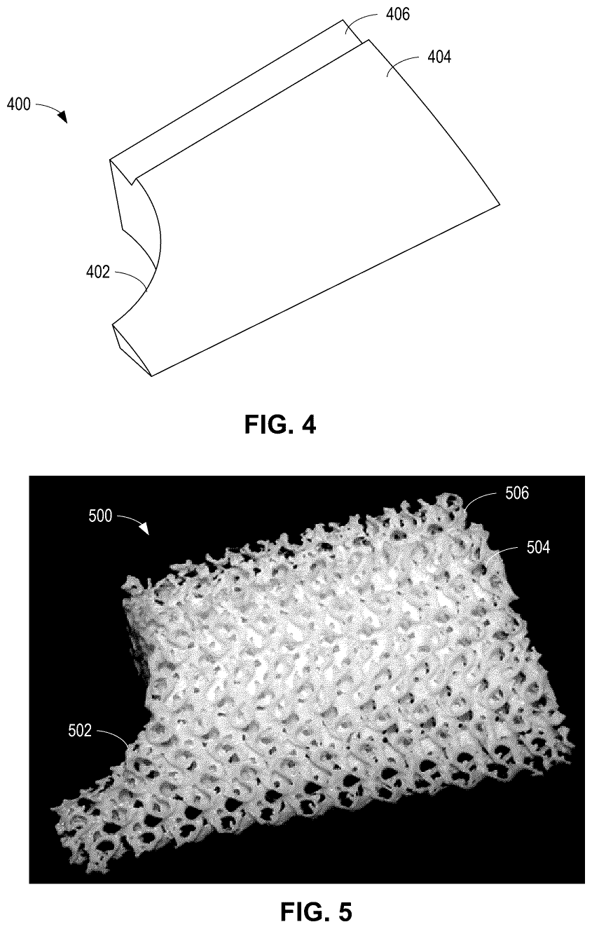

FIG. 4 illustrates an example foam insert 400 formed via additive manufacturing in accordance with teachings of this disclosure. The example foam insert 400 is formed by printing a solid three-dimensional object using, for example, material extrusion. In particular, the foam insert 400 printed via additive manufacture has structural features or properties based on, based on the fuel tank in which the foam insert 400 is be disposed. Properties of the foam insert 400 can be affected by, for instance, a size of the fuel tank, location of sensors or structures such as ribs relative to the fuel tank, etc. The structural properties of the foam insert 400 that can be affected by the properties of the fuel tank and/or, more generally, the aircraft environment include, for example, a size of the foam insert 400, a shape of foam insert 400, whether or not the foam insert 400 includes features such as grooves or notched surfaces and where those features are located, etc. For example, the foam insert 400 of FIG. 4 includes a curved portion 402. Also, the foam insert 400 of FIG. 4 includes a first portion 404 having a first height and a second portion 406 having a second height less than the first height.

To form the example foam insert 400 of FIG. 4, a heated nozzle can deposit layers of melted polyurethane in a shape defined by, for instance, a three-dimensional (3D) model (e.g., a computer-aided design (CAD) model) of the foam insert 400. The 3D model of the foam insert 400 can be based on known structural features of the fuel tank (e.g., the fuel tank 108) in which the foam insert 400 is to be inserted. The 3D model defines a shape profile of the foam insert 400 that is to be printed. For example, the 3D model can define a height of the foam insert 400 or portions thereof. The 3D model can define angle(s) of curvature of one or more portions of the foam insert 400. The 3D model can define locations of grooves, notches, etc. of the foam insert 400.

During formation of the example foam insert 400 of FIG. 4, the deposited layers of material bind or adhere together to form a solid object having a shape profile corresponding to the 3D model. The solid object undergoes a chemical quenching process in which the solid object is exposed to a caustic solution that causes voids or pockets to be formed in the object. As a result of the chemical quenching, a reticulated polyurethane foam is formed. In particular, the voids or pockets formed in the foam insert 400 via quenching creates a porous structure through which fuel in the fuel tank can flow while reducing sloshing of the fluid in the tank.

Thus, the example foam insert 400 formed via additive material already has geometric feature(s) that account for the fuel tank structure prior to the quenching. As such, further shaping of the foam bun after quenching via, for instance, subtractive manufacturing is not needed. Rather, the foam insert 400 is ready for insertion into the fuel tank after the quenching process because the foam insert 400 was built with a shape profile that was designed based on one or more properties of the fuel tank.

FIG. 5 illustrates another example foam insert 500 formed via additive manufacturing in accordance with teachings of this disclosure. Similar to the example foam insert 400 of FIG. 4, the example foam insert 500 was built using additive manufacturing based on a shape profile (e.g., dimensions, contours, cutouts) that accounts for structural features of the fuel tank (e.g., the presence of ribs) in which the foam insert 500 is to be disposed.

The example foam insert 500 of FIG. 5 is formed by depositing foam in the form of a lattice structure, where a perimeter or boundary of the lattice structure defines a shape of the foam insert 500. For example, the lattice structure defining the foam insert 500 of FIG. 5 includes a curved portion 502 similar to the foam insert 400 of FIG. 4. Also, the foam insert 500 includes a first portion 504 having a first height and a second portion 506 having a second height less than the first height.

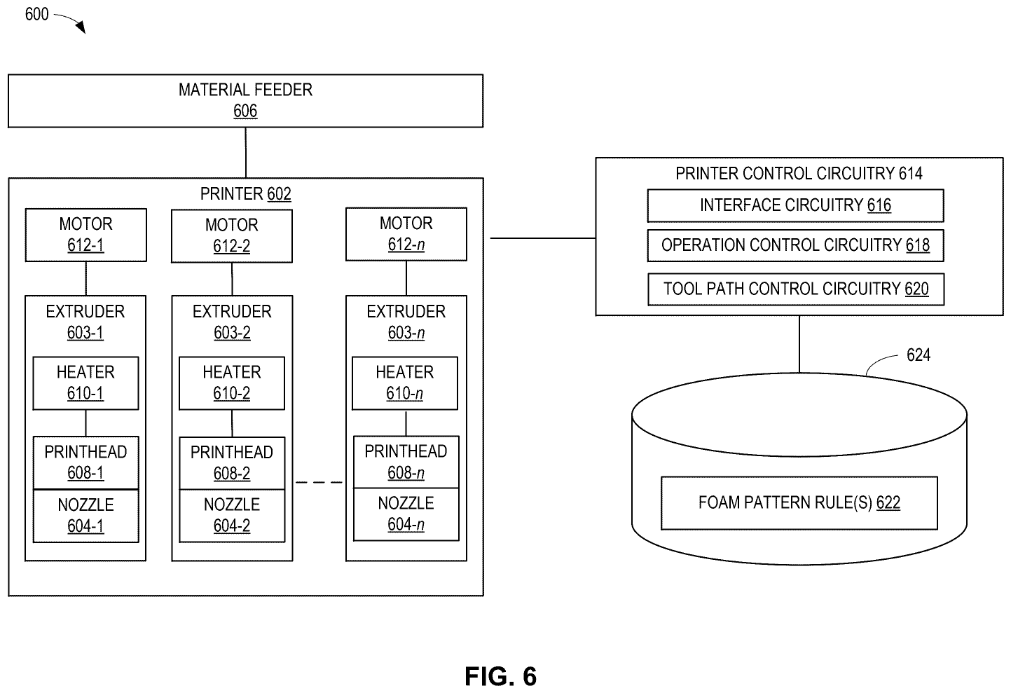

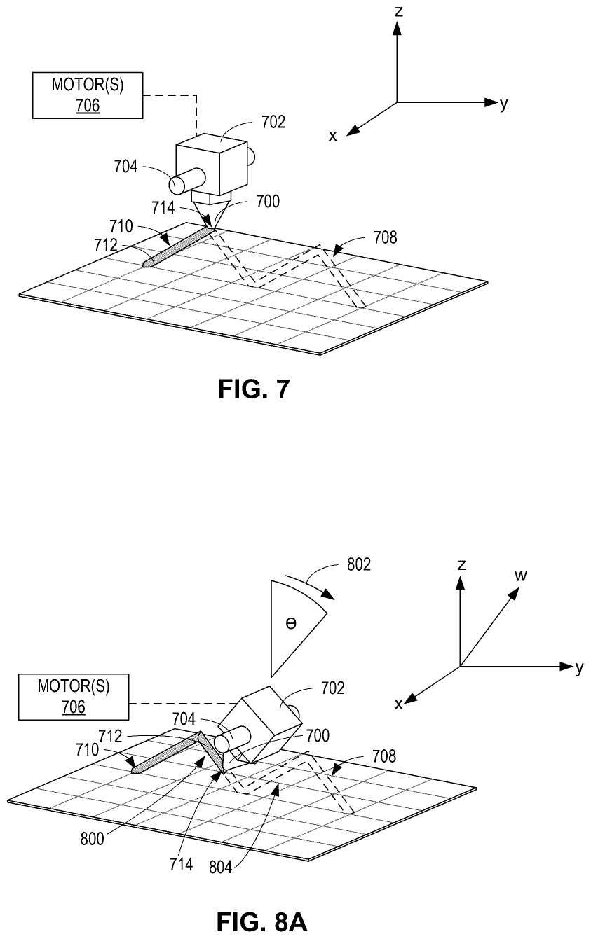

As disclosed in connection with FIGS. 6-12, a controller (e.g., processor circuitry) can generate instructions to cause a nozzle of an extruder to deposit thermal polyurethane while moving along a tool path relative to an x-y-z coordinate system. As the nozzle moves along the tool path, the nozzle deposits foam to form, for example, a first portion of the lattice structure or framework (e.g., as shown in FIGS. 7-12). Additional nozzles moving along respective tool paths can form other portions of the lattice structure. The nozzles can move along tool paths to define layers of the lattice pattern in a repeated arrangement to build the foam insert.

In the example of FIG. 5, the lattice structure includes openings or pockets between the foam portions (e.g., foam strips) deposited by the nozzle. Thus, after the formation of the foam lattice structure in the shape defining the foam insert 500, the foam does not need to undergo additional processing (e.g., quenching) to form pockets or openings in the foam. Rather, the lattice pattern formed by the foam defines the voids.

Thus, FIGS. 4 and 5 illustrate example foam inserts 400, 500 formed using two different additive manufacturing processes. The example foam insert 400 of FIG. 4 is formed by depositing layers of a polyurethane material and then quenching the resulting foam bun to form reticulated polyurethane foam that has open cells or pocket. The example of foam insert 500 of FIG. 5 is formed by depositing a polyurethane material in a lattice pattern with openings defined between portions of the foam structure. In some examples, the formation of the foam insert using a lattice pattern as disclosed in connection with FIG. 5 may be selected over the forming the foam insert using quenching as disclosed in connection with FIG. 4 for purposes of forming, for example, a foam insert having a substantially planar surfaces.

FIG. 6 is a block diagram of an example additive manufacturing system 600 for forming a three-dimensional foam insert using additive manufacturing. The example additive manufacturing system 600 of FIG. 6 will primarily be discussed in connection with printing of the example foam insert 500 of FIG. 5 using the lattice pattern. However, the additive manufacturing system 600 of FIG. 6 can be used to form the example foam insert 400 of FIG. 4 prior to quenching.

The example system 600 includes a printer 602. In the example of FIG. 6, the printer 602 includes one or more extruders 603 (e.g., a first extruder 603-1, a second extrude 603-2, an n^{th} extruder 603-n) to form one or more portions of the foam insert. Each extruder 603 includes a nozzle 604 (e.g., a first nozzle 604-1, a second nozzle 604-2, an n^{th} nozzle 604-n) through which the material received at the printer 602 via a material feeder 606 is extruded. Each of the nozzles 604 is supported by a printhead 608 (e.g., a first printhead 608-1, a second printhead 608-2, an n^{th} printhead 608-n). The example extruders 603 includes heaters 610 to cause heated material (e.g., polyurethane) to exit the corresponding nozzles 604. Although in the example of FIG. 6, each nozzle 604 is associated with a respective heater 610, in other examples, two or more nozzles maybe associated with one heater 610.

In examples disclosed herein, each of the printheads 608 travel along a respective tool path. The example printer 602 includes one or more motors 612 to output instructions to cause the printheads 608 to move (e.g., translate, rotate). Although the example printer 602 includes more than one motor 612 in view of the multiple extruders 603, in other examples, one motor 612 may drive movement two or more printheads 608 (e.g., via multiple shafts of the motor 612). In the example printer 602, the printheads 608 can move simultaneously or substantially simultaneously along respective tool paths. Thus, the nozzles 604 can deposit material simultaneously or substantially simultaneously to form different portions of a foam insert.

The example additive manufacturing system 600 of FIG. 6 includes printer control circuitry 614 to control the printer 602 and, in particular, movement of the printheads 608 of the extruders 603. The example printer control circuitry 614 of FIG. 6 includes interface circuitry 616 to communicate with the component(s) of the printer 602 (e.g., the motors 612, the heaters 610) to transmit instruction(s) generated by the printer control circuitry 614 to control operation of the printer component(s).

The example printer control circuitry 614 includes operation control circuitry 618. The operation control circuitry 618 controls operation of the printer 602. For example, the operation control circuitry 618 can generate instructions to cause the heater(s) 610 of the extruder(s) 603 to heat the material to be extruded based on a particular temperature. In some examples, the printer 602 include mixer(s) to mix the material received from the material feeder 606. In such examples, the operation control circuitry 618 can generate instructions to control the mixer(s) (e.g., mixing rate, duration). The instructions generated by the operation control circuitry 618 can be transmitted to the printer 602 via the interface circuitry 616. The operation control circuitry 614 can generate instructions to control extrusion of filament by the extruder(s) 603 (e.g., forward, backward (retraction), and stop).

The example printer control circuitry 614 of FIG. 6 includes tool path control circuitry 620. The example tool path control circuitry 620 of FIG. 6 generates instructions to control movement (e.g., translation, rotation) of the printhead(s) 608 along respective tool path(s) to define, for example, the lattice structure of the example foam insert 500 of FIG. 5. The instructions generated by the tool path control circuitry 620 can be executed by, for example, the motor(s) 612 to cause the printhead(s) 608 to move according to the instructions. In the example of FIG. 5, the tool path control circuitry 620 controls movement of the printhead(s) 608 based on foam pattern rule(s) 622. The foam pattern rule(s) 622 can be defined based on user input(s) and stored in a database 624 accessible by the tool path control circuitry 620.

The example foam pattern rule(s) 622 can include 3D models defining shape profiles of the foam inserts to be built by the printer 602. For example, with respect to building the example foam insert 400 of FIG. 4, the foam pattern rule(s) 622 can define a height of the foam bun to be printed, a shape of the foam bun, features such as curved surfaces, grooves, etc. of the foam bun, etc. With respect to building the example foam insert 500 of FIG. 5, the example foam pattern rule(s) 622 can include a 3D model defining a shape profile of the foam insert 500 based on the lattice pattern. For example, the foam pattern rule(s) 622 can define a height of a lattice pattern, a number of layers in the lattice pattern, a size of the spacings between the foam portions defining the lattice pattern, etc.

The foam pattern rule(s) 622 can define properties of the respective tool path(s) to be traveled by the corresponding printhead(s) 608 to form the foam inserts (e.g., the foam inserts 400, 500). For example, the foam pattern rule(s) 622 can define the movement of the printhead(s) 608 to form the layers of the foam bun that is to be quenched to form the foam insert 400 of FIG. 4. With respect to forming the example foam insert 500 of FIG. 5, the foam pattern rule(s) 622 can define tool path(s) for building portion(s) of the lattice structure via material extruded by the corresponding nozzle 604 along the took path(s). For example, the foam pattern rule(s) 622 can indicate angle(s) at which the printhead(s) 608 should rotate to define different portions of the lattice pattern via material extruded from the nozzle(s) 604 when the printhead(s) 608 are moving along different portion of the tool path(s). The foam pattern rule(s) 622 can define a distance that that the printhead(s) 608 are to travel along portion(s) of the tool path(s) while the nozzle(s) 604 deposit material.

In response to, for example, a user input indicating that a foam insert having a first lattice pattern should be formed, the tool path control circuitry 620 of FIG. 6 can retrieve the foam pattern rule(s) 622 for the first lattice pattern. The foam pattern rule(s) 622 can define properties of the pattern such as a height, size of spacings between the foam, number of layers, etc. The foam pattern rule(s) 622 can define the shape profile of the foam insert formed by the lattice pattern, such as recessed surfaces, portions with different heights, etc. The foam pattern rule(s) 622 can define properties of the tool path(s) for the printhead(s) 608 to travel along or follow to form the first lattice pattern, such as angle of rotation(s) of the printhead(s) 608 for depositing material at different portions of the first lattice pattern, distance(s) to be travelled by the printhead(s) 608 to define portions of the first lattice pattern via the material extruded by the nozzle(s) 604, etc. The example tool path control circuitry 620 generates instructions to control the printhead(s) 608 and, thus, extrusion of material via the nozzle(s) 604 based on the foam pattern rule(s) 622 for the first lattice pattern. The instructions generated by the tool path control circuitry 620 can be transmitted by the interface circuitry 616 to, for example, the motor(s) 612 associated with the respective printhead(s) 608 that are to be used to define the lattice pattern.

The printheads 608 of the example printer 602 of FIG. 6 can move or translate relative to an x-axis and a y-axis. Additionally, the printheads 608 of the example extruder 603 of FIG. 6 can move (e.g., translate, rotate) relative to a z-axis. For example, based on instructions from the tool path control circuitry 620, the motor(s) 612 can cause the printhead(s) 608 to ascend or descend relative the z-axis relative to the z-axis to follow the tool path(s). Also, in examples disclosed herein, the motor(s) 612 can cause the printhead(s) 608 to move in a fore-after direction relative to a w-axis. The motor(s) 612 can include arms, shafts, linkages, etc. that enable the printhead(s) 608 to move relative to the x, y, and z axes and the w-axis. Thus, the example printer 602 of FIG. 6 can be used to create a lattice structure by moving relative to multiple axes.

FIGS. 7-12 illustrate use of one or more of the printheads 608 of the example printer 602 of FIG. 6 to define a foam insert having a lattice structure, such as the example foam insert 500 of FIG. 5, via additive manufacturing. FIG. 7 illustrates a nozzle 700 (e.g., one of the nozzles 604 of FIG. 6) supported by a printhead 702 (e.g., one of the printheads 608 of FIG. 6). The printhead 702 includes a printhead arm 704. The printhead arm 704 may be supported by, for example, a gantry or other frame that supports at least a portion of the printer 602. In the example of FIG. 7 and based on instruction(s) from the tool path control circuitry 620 of FIG. 6, motor(s) 706 (e.g., one or more of the motors 612 of FIG. 6) cause the printhead 702 to move based on a tool path 708, as represented by the dashed lines in FIG. 7. The example tool path 708 of FIG. 7 defines a portion of a first layer of the lattice structure (e.g., based on the foam pattern rule(s) 622 of FIG. 6). During movement of the printhead 702 along a first portion 710 of the tool path 708, the nozzle 700 deposits material 712 (e.g., heated polyurethane) from an orifice 714 of the nozzle 700.

The motor(s) 706 of FIG. 7 cause the printhead 702 to move relative to an x-y-z axis to travel along the tool path 708. In particular, in the example of FIG. 7, the motor(s) 706 cause the printhead 702 to ascend relative to the z-axis when traveling along the first portion 710 of the tool path 708. As the printhead 702 translates (e.g., moves along the x-axis) and ascends the z-axis, the material 712 exits and moves down from the orifice 714 of the nozzle 700 to form a portion of the lattice structure, as shown in FIG. 7. The motor(s) 706 cause the printhead 702 to ascend along the z-axis until a maximum height of the layer of the lattice structure to be formed by the material 712 is reached.

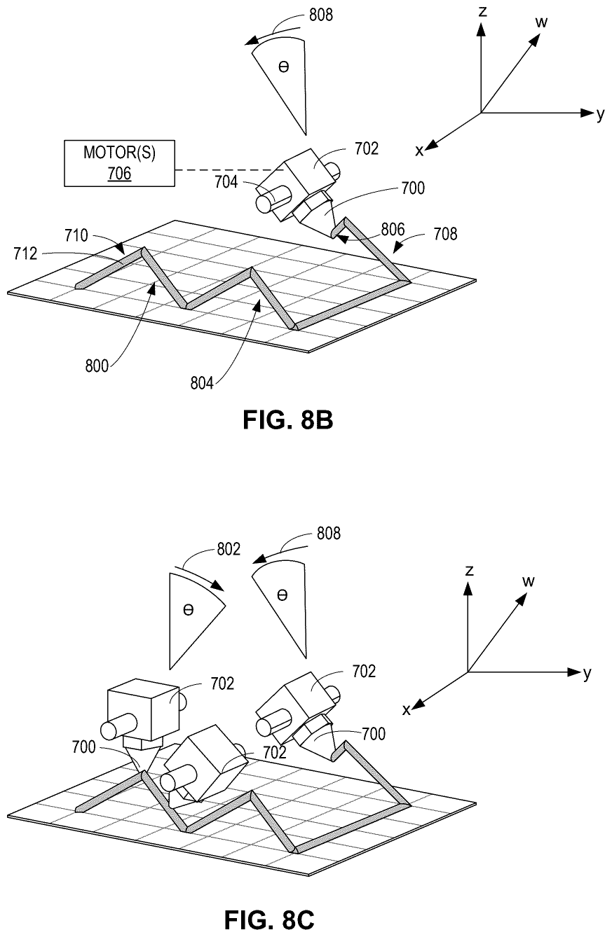

FIG. 8A illustrates movement of the printhead 702 of FIG. 7 along a second portion 800 of the tool path 708. As shown in FIG. 8A, the second portion 800 of the tool path 708 is disposed at an angle relative to the first portion 710 of the tool path 708 shown in FIG. 7 to define, for example, pockets in the lattice foam structure. Thus, to follow the second portion 800 of the tool path 708, the motor(s) 706 cause the printhead 702 to descend relative to the z-axis (e.g., based on instruction(s) from the tool path control circuitry 620 of FIG. 6). As shown in FIG. 8A, the downward sloping angle of the second portion 800 of the tool path 708 is different from upward sloping angle of the first portion 710 of the tool path shown in FIG. 7. Accordingly, the motor(s) 706 cause the printhead 702 to rotate (e.g., via the printhead arm 704 and based on instruction(s) from the tool path control circuitry 620 of FIG. 6) about a w-axis (e.g., fore-aft axis) to cause the nozzle 700 to deposit the material 712 along the second portion 800 of the tool path 708, as represented by arrow 802 in FIG. 8A. In particular, in the example of FIG. 8A, the motor(s) 706 cause the printhead 702 to rotate in a fore direction (e.g., pitch forward) relative to the w-axis so that nozzle 700 is perpendicular or substantially perpendicular to the downward sloping portion 800 of the tool path 708. As a result of this rotation of the printhead 702, the material 712 exits the orifice 714 of the nozzle 700 without being smeared against an exterior surface of the nozzle 700 as the printhead 702 descends along the z-axis while traveling along the second portion 800 of the tool path 708. Thus, the rotation of the printhead 702 about the w-axis in the fore-aft direction prevents interferences of the nozzle 700 with extrusion of the material 712 and formation of the lattice pattern. The motor(s) 706 cause the printhead 702 to descend along the z-axis until a change in the tool path 708 is encountered, such as a change to another upward sloping portion 804 (e.g., a third portion 804) of the tool path 708.

FIG. 8B illustrates movement of the printhead 702 of FIG. 7 along a fourth portion 806 of the tool path 708. As shown in FIG. 8B, the printhead 702 has moved along the tool path 708 from the first, second, and third portions 710, 800, 804. In particular, based on the tool path 708, the motor(s) 706 cause the printhead 702 to move along the fourth portion 806 in an opposite direction relative to the y-axis than when moving along the first, second, and third portions 710, 800, 804 of the tool path 708. To deposit material along the fourth portion 806 of the tool path 708 via the nozzle 700 without interfering with the extruded material 712, the motor(s) 706 cause the printhead 702 to rotate (e.g., via the printhead arm 704 and based on instruction(s) from the tool path control circuitry 620 of FIG. 6) in an aft direction (e.g., pitch backward) about the w-axis, as represented by arrow 808 in FIG. 8B. Also, the motor(s) 706 cause the printhead 702 to descend along the z-axis based on the fourth portion 806 of the tool path 708.

FIG. 8C illustrates the progression of movement of the printhead 702 along the example tool path 708 disclosed in connection with FIGS. 7, 8A, and 8B. In particular, FIG. 8C illustrates rotation of the printhead 702 in the fore-aft direction relative to the w-axis during formation of the lattice pattern disclosed in connection with FIGS. 8A and 8B. As disclosed herein, the rotation of the printhead 702 about the w-axis in the fore-aft direction allows the nozzle 700 to be perpendicular or substantially perpendicular to the sloping portions (e.g., downward sloping portion(s), upward sloping portion(s)) of the tool path 708. For example, the printhead 702 can pitch forward when moving in a first direction along the y-axis and pitch backward when moving in a second, or opposite direction along the y-axis. As a result, the lattice pattern can be formed without interference (e.g., smearing) by the nozzle 700 during extrusion.

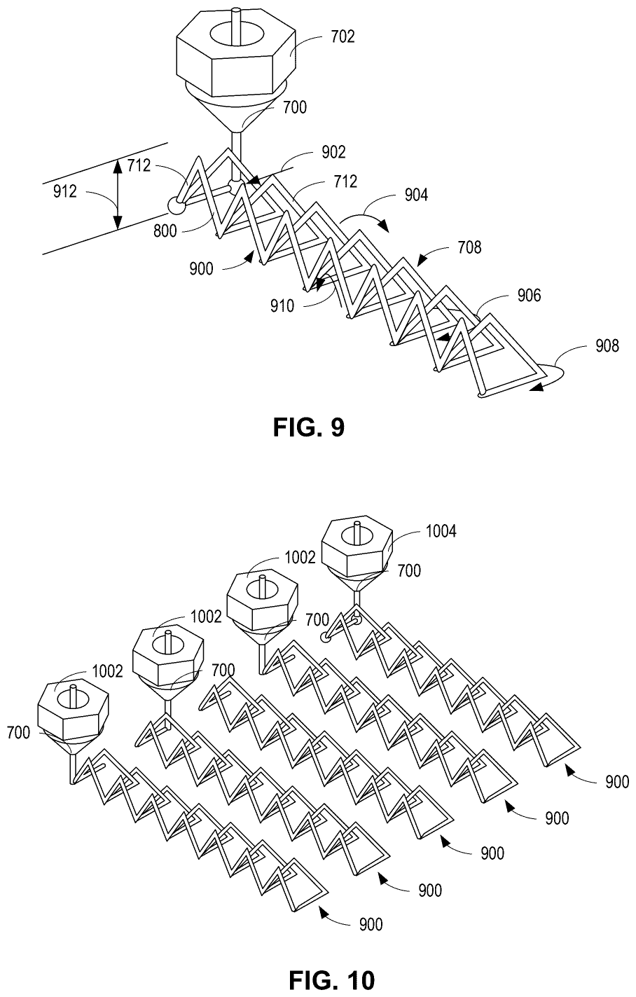

FIG. 9 illustrates a first portion 900 of a first layer of a lattice structure of a foam insert (e.g., the foam insert 500 of FIG. 5). The first portion 900 of the first layer of that lattice structure is formed as a result of movement of the printhead 702 along the tool path 708, including, for example, along portions 710, 800, 804, 806 of the tool path 708 as discussed in connection with FIGS. 7 and 8A-8C. The motor(s) 706 cause the printhead 702 to move (e.g., translation) relative to the x, y, and/or z axes and to rotate about one or more axes (e.g., w-axis) based on the tool path 708. For example, arrows 902, 904, 906, 908, 910 in FIG. 9 show a sequence of movement of the printhead 702 such that the nozzle 700 deposits the material 712 in the lattice pattern (e.g., a chain link pattern) defined by the tool path 708. Also, arrow 912 in FIG. 9 represents a height of the first layer of the lattice structure that includes the first portion 900.

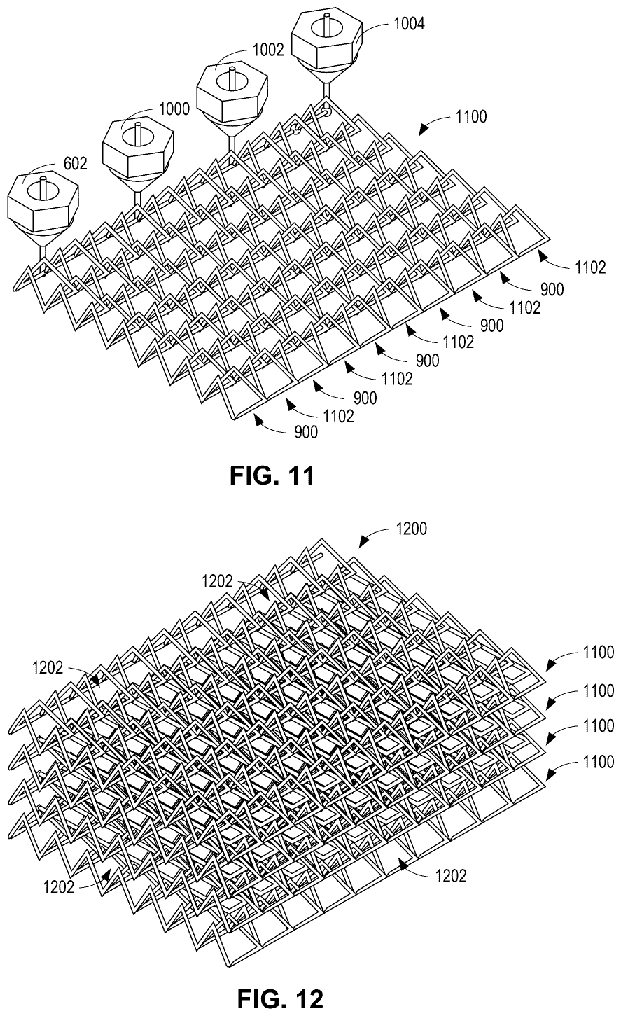

FIGS. 10 and 11 illustrate the use of multiple printheads 702, 1000, 1002, 1004 (e.g., the printheads 608 of FIG. 6) traveling along respective tool paths in alignment with each other to form a first layer 1100 (FIG. 11) of a lattice structure for a foam insert (e.g., the foam insert 500 of FIG. 5). Based on instruction(s) from the tool path control circuitry 620 of FIG. 6, the motor(s) 706 (FIG. 7) cause each of the printheads 702, 1000, 1002, 1004 to move to form respective first portions 900 of the first layer of the lattice pattern as disclosed in connection with FIG. 9. Also, based on the instructions from the operation control circuitry 618 of FIG. 6, the extrusion of material or filament via the respective nozzle(s) 700 can be controlled. For example, the operation control circuitry 618 can cause extrusion to be stopped at a particular printhead 702, 1000, 1002, 1004 when there is no need for material in that location relative to the object being formed.

As shown in FIG. 10, the nozzles 700 carried by the respective printheads 702, 1000, 1002, 1004 are spaced apart from one each other (e.g., because of the size of the printheads 702, 1000, 1002, 1004 and/or to enable concurrent operation without interference from adjacent printheads). As a result, the distance between the first portions 900 may exceed a preferred size of the pockets of the foam insert. To address the spacings between the first portions 900, additional toolpaths can be defined to cause second portions 1102 (FIG. 11) to be formed between the first portions 900 to reduce the size of the pockets in the lattice pattern. As shown in FIG. 11, the second portions 1102 can be formed via movement of the printheads 702, 1000, 1002, 1004, where the second portion 1102 are formed in between the first portions 900 (e.g., rows between the first portions 900). The first and second portions 900, 1102 can define the first layer 1100 of the lattice structure.

FIG. 12 illustrates a lattice structure 1200 formed via the additive manufacturing process disclosed in connection with FIGS. 7-11. The motor(s) 706 cause the printheads 702, 1000, 1002, 1004 to move to form additional layers 1100 of the lattice structure 1200 based on a desired height of the lattice structure (e.g., where the desired height is defined based on the foam pattern rule(s) 622 of FIG. 6). As shown in FIG. 12, openings or pockets 1202 are defined by the lattice pattern (e.g., the portions 900, 1102, the layers 1100), Thus, the example printer 602 of FIG. 6 can be used to form a lattice structure 1200 via material extrusion and based on movement (e.g., translation, rotation) of the printheads 702, 1000, 1002, 1004.

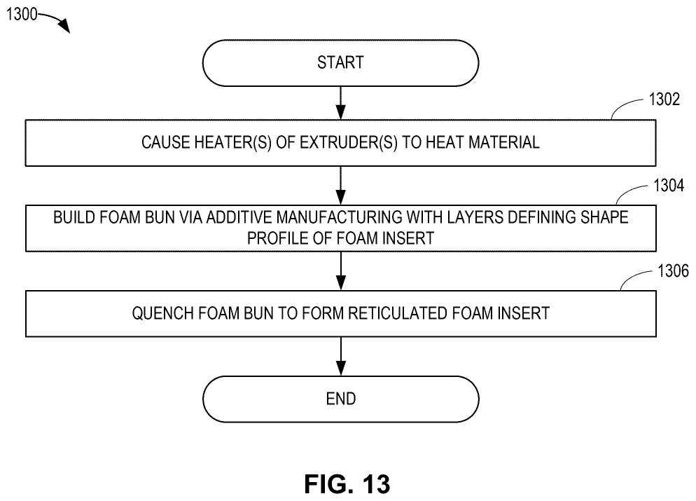

FIG. 13 is flowchart of an example method 1300 for forming a foam insert for a fuel tank via additive manufacturing, such as the example foam insert 400 of FIG. 4. At block 1302, the operation control circuitry 618 of the example printer control circuitry 614 of FIG. 6 causes the heater(s) 610 of the extruder(s) 603 to heat a material 712 for forming the foam insert, such as polyurethane. At block 1304, the printer control circuitry 614 causes a foam bun to be formed via additive manufacturing and having a shape profile (e.g., a geometry, a size, dimensions, surface features such as openings, notches, curved surfaces, etc.) based on one or more properties of a fuel tank in which the foam insert is to be disposed. The foam insert can be formed using the example printer 602 of FIG. 6 based on instructions generated by the tool path control circuitry 620 of the printer control circuitry 614 using, for example, a 3D model defined by the foam pattern rule(s) 622. The 3D model for the foam insert can be based on one or more structural properties of the fuel tank in which the foam insert is to be disposed. The printhead(s) 608 of the printer 602 can move (e.g., based on instruction(s) from the tool path control circuitry 620) to cause the nozzle(s) 604 to deposit layers of heated polyurethane to build a foam bun having a shape profile corresponding to the 3D model for the foam insert.

At block 1306, the example method 1300 of FIG. 13 includes quenching the foam bun to form a reticulated foam insert. For example, the foam bum can be exposed to a caustic bath to remove cell membranes of the foam and create voids, open cells, or pockets in the polyurethane. As a result of the example method 1300 of FIG. 13, a foam insert of reticulated, low resistance foam is formed for insertion into a fuel tank.

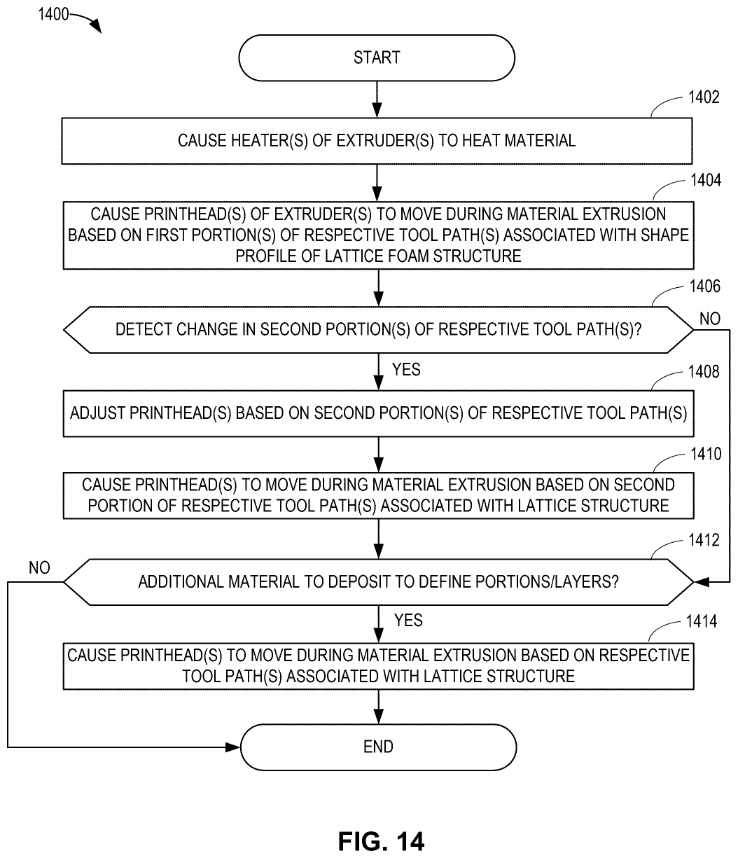

FIG. 14 is a flowchart representative of example machine-readable instructions and/or example operations 1400 that may be executed, instantiated, and/or performed by programmable circuitry to build a foam insert having a lattice structure 1200, such as the example foam insert 500 of FIG. 5. The example instructions of FIG. 14 can be executed to control operation of one or more of the extruders 603 of the example printer 602 of FIG. 6 (e.g., movement of two or more extruders to form different portions of the lattice structure simultaneously or substantially simultaneously). The example machine-readable instructions and/or the example operations 1400 of FIG. 14 begin at block 1402, at which the operation control circuitry causes heater(s) 610 of the extruder(s) 603 to heat a material 712 for forming the foam insert, such as polyurethane.

At block 1404, the tool path control circuitry 620 causes the motor(s) 612, 706 to cause the printhead(s) 608, 702 of the extruder(s) 603 to move based on first portion(s) of respective tool path(s) 708 (e.g., the first portion 710 of the example tool path 708) defined for each of the extruder(s) 603. The tool path(s) 708 are associated with the shape profile of the resulting foam insert defined by the lattice structure 1200. The tool path(s) 708 can be defined by the foam pattern rule(s) 622 based on, for example, a 3D model defining the shape profile of the foam insert (e.g., properties of the lattice pattern, dimensions, structural features such as portions having different heights, etc.). The foam pattern rule(s) 622 define the shape profile based on properties of the fuel tank in which the foam insert is to be installed, such as a shape of the fuel tank; the presence of sensor(s), piping, spares, etc. in at least a portion of an interior of the fuel tank; etc. During movement of the printhead(s) 608, 702 along the first portion(s) 710 of the tool path(s) 708, the material 712 is deposited via the nozzle(s) 604, 700 of the extruder(s) 603 define portion(s) 900, 1102 of the lattice structure 1200.

At block 1406, the tool path control circuitry 620 determines if there is a change in second portion(s) of the respective tool path(s) 708, such as change from an upward sloping first portion of the tool path (e.g., the first portion 710 of the example tool path 708 of FIG. 7) to a downward sloping second portion of a tool path (e.g., the second portion 800 of the example tool path 708 of FIG. 8A, the fourth portion 806 of the example tool path 708 of FIG. 8B) to define, for example, openings or pockets in the lattice structure 1200.

At block 1408 and in response to change of the second portion(s) of the tool path(s) 708 relative to the first portion(s) of the tool path(s), the tool path control circuitry 620 can instruct the motor(s) 612, 706 to adjust the printhead(s) 608, 702 relative to one or more of an x-axis, y-axis, z-axis, or w-axis (fore-aft axis) to, for example, prevent interference between the extruder(s) 603 and the tool path(s) 708 (e.g., smearing of extruded material on the nozzle(s) 604, 700). For example, the tool path control circuitry 620 can instruct the motor(s) 612, 706 to cause the printhead(s) 608, 702 to rotate in a fore-aft direction relative to a w-axis so that the nozzle(s) 604, 700 are perpendicular or substantially perpendicular to downward sloping portion(s) of the tool path(s) 708.

At block 1410, the tool path control circuitry 620 causes the motor(s) 612, 706 to move based on the second portion(s) of the respective tool path(s) 708. The material 712 is deposited via the nozzle(s) 604, 700 of the extruder(s) 603 define additional portion(s) 900, 1102 of the lattice structure 1200 during movement of the printhead(s) 608, 702 along the second portion of the tool path(s) 708.

If there is additional material to deposit (block 1412) to form portions 900, 1102, layers 1100, etc. of the lattice structure 1200 of the foam insert, then the tool path control circuitry 620 continues to instruct the motor(s) 612, 706 to cause the printhead(s) 608, 702 to move (e.g., translate and/or rotate relative to one or more axes) based on the tool path(s) 708 for the printhead(s) 608 (block 1414). The example instructions 1400 of FIG. 14 end when no further material is to be deposited and, thus, the foam insert is complete.

A block diagram of an example implementation of the printer control circuitry 614 to control the example printer 602 for forming a foam insert for a fuel tank is shown in FIG. 6. The printer control circuitry 614 of FIG. 6 may be instantiated (e.g., creating an instance of, bring into being for any length of time, materialize, implement, etc.) by programmable circuitry such as a Central Processor Unit (CPU) executing first instructions. Additionally or alternatively, the printer control circuitry 614 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

In some examples, the operation control circuitry 618 is instantiated by programmable circuitry executing operation control circuitry instructions and/or configured to perform operations such as those represented by the flowchart(s) of FIG. 14. In some examples, the tool path control circuitry 620 is instantiated by programmable circuitry executing nozzle path circuitry instructions and/or configured to perform operations such as those represented by the flowchart(s) of FIG. 14.

While an example manner of implementing the printer control circuitry 614 is illustrated in FIG. 6, one or more of the elements, processes, and/or devices illustrated in FIG. 6 may be combined, divided, re-arranged, omitted, eliminated, and/or implemented in any other way. Further, the example interface circuitry 616, the example operation control circuitry 618, the example tool path control circuitry 620 and/or, more generally, the example printer control circuitry 614 of FIG. 6, may be implemented by hardware alone or by hardware in combination with software and/or firmware. Thus, for example, any of the example interface circuitry 616, the example operation control circuitry 618, the example tool path control circuitry 620, and/or, more generally, the example printer control circuitry 614, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example printer control circuitry 614 of FIG. 6 may include one or more elements, processes, and/or devices in addition to, or instead of, those illustrated in FIG. 6, and/or may include more than one of any or all of the illustrated elements, processes and devices.

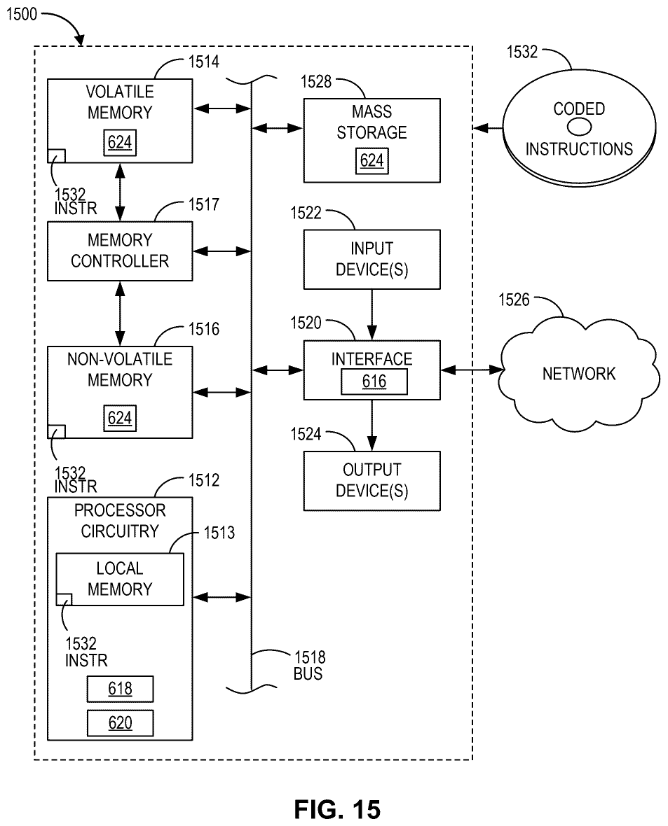

The flowcharts of FIG. 13 (e.g., block 1302, 1304) and/or FIG. 14 are representative of example machine-readable instructions, which may be executed by programmable circuitry to implement and/or instantiate the printer control circuitry 614 of FIG. 6 and/or representative of example operations which may be performed by programmable circuitry to implement and/or instantiate the printer control circuitry 614 of FIG. 6. The machine-readable instructions may be one or more executable programs or portion(s) of one or more executable programs for execution by programmable circuitry such as the programmable circuitry 1512 shown in the example processor platform 1500 discussed below in connection with FIG. 15 and/or may be one or more function(s) or portion(s) of functions to be performed by the example programmable circuitry (e.g., an FPGA). In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart illustrated in FIG. 6, many other methods of implementing the example printer control circuitry 614 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 13 (e.g., blocks 1302, 1304) and/or FIG. 14 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 15 is a block diagram of an example programmable circuitry platform 1500 structured to execute and/or instantiate the example machine-readable instructions and/or the example operations of FIG. 13 (e.g., blocks 1302, 1304) and/or FIG. 14 to implement the printer control circuitry 614 of FIG. 6. The programmable circuitry platform 1500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 1500 of the illustrated example includes programmable circuitry 1512. The programmable circuitry 1512 of the illustrated example is hardware. For example, the programmable circuitry 1512 can be implemented by one or more integrated circuits, logic circuits, FPGAs, microprocessors, CPUs, GPUs, DSPs, and/or microcontrollers from any desired family or manufacturer. The programmable circuitry 1512 may be implemented by one or more semiconductor based (e.g., silicon based) devices. In this example, the programmable circuitry 1512 implements the example operation control circuitry 618 and the example tool path control circuitry 620.

The programmable circuitry 1512 of the illustrated example includes a local memory 1513 (e.g., a cache, registers, etc.). The programmable circuitry 1512 of the illustrated example is in communication with main memory 1514, 1516, which includes a volatile memory 1514 and a non-volatile memory 1516, by a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1516 may be implemented by flash memory and/or any other desired type of memory device. Access to the main memory 1514, 1516 of the illustrated example is controlled by a memory controller 1517. In some examples, the memory controller 1517 may be implemented by one or more integrated circuits, logic circuits, microcontrollers from any desired family or manufacturer, or any other type of circuitry to manage the flow of data going to and from the main memory 1514, 1516.

The programmable circuitry platform 1500 of the illustrated example also includes interface circuitry 1520. The interface circuitry 1520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1522 are connected to the interface circuitry 1520. The input device(s) 1522 permit(s) a user (e.g., a human user, a machine user, etc.) to enter data and/or commands into the programmable circuitry 1512. The input device(s) 1522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1524 are also connected to the interface circuitry 1520 of the illustrated example. The output device(s) 1524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1520 of the illustrated example, thus, typically includes a graphics driver card, a graphics driver chip, and/or graphics processor circuitry such as a GPU.

The interface circuitry 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1500 of the illustrated example also includes one or more mass storage discs or devices 1528 to store firmware, software, and/or data. Examples of such mass storage discs or devices 1528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1532, which may be implemented by the machine-readable instructions of FIG. 14, may be stored in the mass storage device 1528, in the volatile memory 1514, in the non-volatile memory 1516, and/or on at least one non-transitory computer-readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide for formation of foam inserts for fuel tanks using additive manufacturing. Examples disclosed herein build a foam insert for inserting in a fuel tank based on a 3D model that defines a shape profile for the foam insert, where the shape profile accounts for structural features of the fuel tank and/or components thereof, such as sensors, ribs, piping, etc. Because examples disclosed herein print the foam insert in a shape that accounts for properties of the fuel tank, examples disclosed herein eliminate the need for cutting the foam bun into a particular shape, as compared to subtractive manufacturing processes. Some examples disclosed herein provide for an extruder that can rotate in a fore-aft direction to enable formation of foam inserts having a lattice structure. Examples disclosed herein provide for efficient formation of foam inserts for fuel tanks via additive manufacturing.

Example systems, apparatus, and methods to provide for manufacturing foam inserts for fuel tanks are disclosed herein. Further examples and combinations thereof include the following:

Example 1 includes a method comprising forming, via additive manufacturing, a foam insert having a shape based on one or more properties of a fuel tank that is to receive the foam insert; and quenching the foam insert to form a reticulated foam insert.

Example 2 includes the method of example 1, wherein a material of the reticulated foam insert includes polyurethane.

Example 3 includes the method of examples 1 or 2, wherein the one or more properties of the fuel tank include one or more of a presence of a sensor in the fuel tank or a presence of a rib of an aircraft at least partially in the fuel tank.

Example 4 includes the method of any of examples 1-3, wherein forming the foam insert includes depositing layers of material based on a three-dimensional model defining the shape of the foam insert.

Example 5 includes the method of any of examples 1-4, wherein the foam insert is a first foam insert, the shape is a first shape, the reticulated foam insert is a first reticulated foam insert, the one or more properties of the fuel tank includes a first property and second property, the first property different from the second property, and further including forming the first foam insert based on the first property of the fuel tank; forming, via additive manufacturing, a second foam insert having a second shape based on the second property of the fuel tank; and quenching the second foam insert to form a second reticulated foam insert.

Example 6 includes a system comprising a printer including a first extruder, the first extruder including a first printhead and a first nozzle; machine-readable instructions; and at least one processor circuit to be programmed by the machine-readable instructions to: cause the first printhead to move along a first portion of a tool path, the first portion of the tool path defining a first portion of a foam insert for a fuel tank, the first printhead disposed at a first angle relative to the first portion of the tool path, the first nozzle to deposit material to form the first portion of the foam insert during movement of the first printhead along the first portion of the tool path; cause the first printhead to rotate in a fore-aft direction to a second angle relative to a second portion of the tool path, the second portion of the tool path defining a second portion of the foam insert; and cause the first printhead to move along the second portion of the tool path, the first nozzle to deposit the material to form the second portion of the foam insert during moving of the first printhead along the second portion of the tool path.

Example 7 includes the system of example 6, wherein the printer includes one or more motors operatively coupled to the first extruder and the one or more of the at least one processor circuit is to cause the first printhead to move relative to one or more of a first axis, a second axis, a third axis, or a fourth axis via the one or more motors, wherein the fourth axis is associated with the fore-aft direction.

Example 8 includes the system of examples 6 or 7, wherein the first portion and the second portion of the foam insert define a portion of a lattice pattern, the lattice pattern defining a shape of the foam insert.

Example 9 includes the system of any of examples 6-8, wherein the shape of the foam insert is based on a structural feature of the fuel tank.

Example 10 includes the system of any of examples 6-9, wherein when the first printhead is at the second angle, the first nozzle is perpendicular to the second portion of the tool path.

Example 11 includes the system of any of examples 6-10, wherein the tool path is a first tool path, the first portion and the second portion of the foam insert define a first layer of the foam insert, and wherein one or more of the at least one processor circuit is to cause the first printhead to move along a second tool path, the second tool path defining a portion of a second layer of the foam insert, the first nozzle to deposit the material to form the portion of the second layer of the foam insert during movement of the printhead along the second tool path.

Example 12 includes the system of any of examples 6-11, wherein the tool path is a first tool path and the printer further includes a second extruder, the second extruder including a second printhead and a second nozzle, and one or more of the at least one processor circuit is to cause the second printhead to move along a second tool path, the second tool path defining a third portion of the foam insert, the second nozzle to deposit the material to form the third portion of the foam insert during movement of the second printhead along the second tool path.

Example 13 includes the system of any of examples 6-12, wherein the second printhead is to move along a first portion of the second tool path at a same time the first printhead moves along the first portion of the first tool path.

Example 14 includes at least one non-transitory machine-readable medium comprising machine-readable instructions to cause at least one processor circuit to at least cause a printer to deposit material to form a first portion of a lattice structure of a foam insert for a fuel tank; and cause the printer to deposit the material to form a second portion of the lattice structure of the foam insert, the first portion and the second portion of the lattice structure defining a shape profile of the foam insert, the shape profile based on a property of an interior of the fuel tank.

Example 15 includes the at least one non-transitory machine-readable medium of example 14, wherein the printer includes a first extruder and the machine-readable instructions are cause one or more of the least one processor circuit to cause the first extruder to move in a first direction to form the first portion of the lattice structure and to move in a second direction to form the second portion of the lattice structure, the first direction opposite the second direction.

Example 16 includes the at least one non-transitory machine-readable medium of examples 14 or 15, wherein the machine-readable instructions are cause one or more of the least one processor circuit to cause a printhead of the first extruder to rotate in a fore-aft direction to cause the first extruder to move from the first direction to the second direction.

Example 17 includes the at least one non-transitory machine-readable medium of any of examples 14-16, wherein the printer includes a second extruder and the machine-readable instructions are to cause one or more of the least one processor circuit to cause the second extruder to move to form a second portion of the lattice structure during movement of the first extruder.

Example 18 includes the at least one non-transitory machine-readable medium of any of examples 14-17, wherein the machine-readable instructions are to cause one or more of the least one processor circuit to cause one of the first extruder or the second extruder to move to form a third portion of the lattice structure based on a size of openings of the lattice structure defined by the shape profile, the third portion between the first portion and the second portion.

Example 19 includes the at least one non-transitory machine-readable medium of any of examples 14-18, wherein the shape profile defines a curved portion of the foam insert.

Example 20 includes the at least one non-transitory machine-readable medium of any of examples 14-19, wherein the first portion and the second portion form a first layer of the lattice structure and the machine-readable instructions are to cause one or more of the least one processor circuit to cause the printer to move to form a second layer of the lattice structure.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A method comprising:
forming, via additive manufacturing, a foam insert having a shape based on one or more properties of a fuel tank that is to receive the foam insert; and
quenching the foam insert to form a reticulated foam insert.

2. The method of claim 1, wherein a material of the reticulated foam insert includes polyurethane.

3. The method of claim 1, wherein the one or more properties of the fuel tank include one or more of a presence of a sensor in the fuel tank or a presence of a rib of an aircraft at least partially in the fuel tank.

4. The method of claim 1, wherein forming the foam insert includes depositing layers of material based on a three-dimensional model defining the shape of the foam insert.

5. The method of claim 1, wherein the foam insert is a first foam insert, the shape is a first shape, the reticulated foam insert is a first reticulated foam insert, the one or more properties of the fuel tank includes a first property and second property, the first property different from the second property, and further including:
forming the first foam insert based on the first property of the fuel tank;
forming, via additive manufacturing, a second foam insert having a second shape based on the second property of the fuel tank; and
quenching the second foam insert to form a second reticulated foam insert.

6. A system comprising:
a printer including a first extruder, the first extruder including a first printhead and a first nozzle;
machine-readable instructions; and
at least one processor circuit to be programmed by the machine-readable instructions to:
cause the first printhead to move along a first portion of a tool path, the first portion of the tool path defining a first portion of a foam insert for a fuel tank, the first printhead disposed at a first angle relative to the first portion of the tool path, the first nozzle to deposit material to form the first portion of the foam insert during movement of the first printhead along the first portion of the tool path;
cause the first printhead to rotate in a fore-aft direction to a second angle relative to a second portion of the tool path, the second portion of the tool path defining a second portion of the foam insert; and
cause the first printhead to move along the second portion of the tool path, the first nozzle to deposit the material to form the second portion of the foam insert during moving of the first printhead along the second portion of the tool path.

7. The system of claim 6, wherein the printer includes one or more motors operatively coupled to the first extruder and the one or more of the at least one processor circuit is to cause the first printhead to move relative to one or more of a first axis, a second axis, a third axis, or a fourth axis via the one or more motors, wherein the fourth axis is associated with the fore-aft direction.

8. The system of claim 6, wherein the first portion and the second portion of the foam insert define a portion of a lattice pattern, the lattice pattern defining a shape of the foam insert.

9. The system of claim 8, wherein the shape of the foam insert is based on a structural feature of the fuel tank.

10. The system of claim 6, wherein when the first printhead is at the second angle, the first nozzle is perpendicular to the second portion of the tool path.

11. The system of claim 6, wherein the tool path is a first tool path, the first portion and the second portion of the foam insert define a first layer of the foam insert, and wherein one or more of the at least one processor circuit is to cause the first printhead to move along a second tool path, the second tool path defining a portion of a second layer of the foam insert, the first nozzle to deposit the material to form the portion of the second layer of the foam insert during movement of the printhead along the second tool path.

12. The system of claim 6, wherein the tool path is a first tool path and the printer further includes a second extruder, the second extruder including a second printhead and a second nozzle, and one or more of the at least one processor circuit is to cause the second printhead to move along a second tool path, the second tool path defining a third portion of the foam insert, the second nozzle to deposit the material to form the third portion of the foam insert during movement of the second printhead along the second tool path.

13. The system of claim 12, wherein the second printhead is to move along a first portion of the second tool path at a same time the first printhead moves along the first portion of the first tool path.

14. At least one non-transitory machine-readable medium comprising machine-readable instructions to cause at least one processor circuit to at least:
cause a printer to deposit material to form a first portion of a lattice structure of a foam insert for a fuel tank; and
cause the printer to deposit the material to form a second portion of the lattice structure of the foam insert, the first portion and the second portion of the lattice structure defining a shape profile of the foam insert, the shape profile based on a property of an interior of the fuel tank.

15. The at least one non-transitory machine-readable medium of claim 14, wherein the printer includes a first extruder and the machine-readable instructions are cause one or more of the least one processor circuit to cause the first extruder to move in a first direction to form the first portion of the lattice structure and to move in a second direction to form the second portion of the lattice structure, the first direction opposite the second direction.

16. The at least one non-transitory machine-readable medium of claim 15, wherein the machine-readable instructions are cause one or more of the least one processor circuit to cause a printhead of the first extruder to rotate in a fore-aft direction to cause the first extruder to move from the first direction to the second direction.

17. The at least one non-transitory machine-readable medium of claim 15, wherein the printer includes a second extruder and the machine-readable instructions are to cause one or more of the least one processor circuit to cause the second extruder to move to form a second portion of the lattice structure during movement of the first extruder.

18. The at least one non-transitory machine-readable medium of claim 17, wherein the machine-readable instructions are to cause one or more of the least one processor circuit to cause one of the first extruder or the second extruder to move to form a third portion of the lattice structure based on a size of openings of the lattice structure defined by the shape profile, the third portion between the first portion and the second portion.

19. The at least one non-transitory machine-readable medium of claim 14, wherein the shape profile defines a curved portion of the foam insert.

20. The at least one non-transitory machine-readable medium of claim 14, wherein the first portion and the second portion form a first layer of the lattice structure and the machine-readable instructions are to cause one or more of the least one processor circuit to cause the printer to move to form a second layer of the lattice structure.
